(19) United States
(12) Patent Application Publication
(10) Pub. No.: US 2025/0373320 A1
(43) Pub. Date: Dec. 4, 2025

(54) RECIPROCAL ARCHITECTURE FOR WIRELESS REPEATERS

(71) Applicant: Samsung Electronics Co., Ltd., Suwon-si (KR)

(72) Inventors: Xinguang Xu, Allen, TX (US); Shenggang Dong, Dallas, TX (US); Chance Anthony Tarver, Arlington, TX (US); Gang Xu, Allen, TX (US); Won Suk Choi, McKinney, TX (US)

(21) Appl. No.: 18/924,964

(22) Filed: Oct. 23, 2024

Related U.S. Application Data
(60) Provisional application No. 63/654,757, filed on May 31, 2024.

(51) Int. Cl. H04B 7/155

(52) U.S. Cl. CPC H04B 7/15585; H04B 7/1555

(57) ABSTRACT

A repeater includes a first antenna configured to transmit and receive RF signals from a BS, a second antenna configured to transmit and receive RF signals from a UE, a processor configured to control an operating mode of the repeater, and a transceiver operatively coupled to the processor. The transceiver includes an amplifier stage and a DPDT switch. The DPDT switch is configured to, when the repeater is operating in a downlink operating mode, electrically couple the first antenna to an input signal path of the amplifier stage, and electrically couple the second antenna to an output signal path of the amplifier stage. The DPDT switch is further configured to, when the repeater is operating in an uplink operating mode, electrically couple the second antenna to the input signal path of the amplifier stage, and electrically couple the first antenna to the output signal path of the amplifier stage.

### CROSS-REFERENCE TO RELATED APPLICATION(S) AND CLAIM OF PRIORITY

This application claims priority under 35 U.S.C. § 119 (e) to U.S. Provisional Patent Application No. 63/654,757 filed on May 31, 2024. The above-identified provisional patent application is hereby incorporated by reference in its entirety.

### TECHNICAL FIELD

This disclosure relates generally to wireless networks. More specifically, this disclosure relates to reciprocal architectures for wireless repeaters.

### BACKGROUND

Fixed wireless access (FWA) services are being deployed as an alternative to fiber installations for home internet. In FWA, the customer premise equipment (CPE) is connected to the base station (BS) by wireless radio waves instead of fiber-optic cables, which is more suitable for areas where wired infrastructure is limited or costly to deploy. C-band (4-8 GHZ) or 5G FR2 mmWave bands are expected to be utilized at first to support FWA services. However, both frequency bands suffer high path loss compared to lower frequency bands, which can limit the FWA node range of coverage.

The signal repeater has been widely used in the wireless and wireline communication systems to overcome excessive path loss. Its main function is to receive, amplify and transmit again the uplink and downlink signal without signal quality degradation. However, existing repeater designs adopt different amplifier chains for uplinks and downlinks, which breaks channel reciprocity in 5G Time Division Duplex (TDD) systems.

### SUMMARY

This disclosure provides reciprocal architectures for wireless repeaters, as well as methods of operating wireless repeaters.

In one embodiment, a repeater is provided. The repeater includes a first antenna configured to transmit and receive radio frequency (RF) signals from a base station (BS), a second antenna configured to transmit and receive RF signals from a user equipment (UE), a processor configured to control an operating mode of the repeater, and a transceiver operatively coupled to the processor. The transceiver includes a first amplifier stage and a first double pole double throw (DPDT) switch. The first DPDT switch is configured to, when the repeater is operating in a downlink operating mode, electrically couple the first antenna to an input signal path of the first amplifier stage, and electrically couple the second antenna to an output signal path of the first amplifier stage. The first DPDT switch is further configured to, when the repeater is operating in an uplink operating mode, electrically couple the second antenna to the input signal path of the first amplifier stage, and electrically couple the first antenna to the output signal path of the first amplifier stage.

In another embodiment, a method of operating a repeater is provided. The method includes controlling a DPDT switch to operate the repeater in one of a downlink operating mode or an uplink operating mode. The first DPDT switch is configured to, when the repeater is operating in the downlink operating mode, electrically couple the first antenna to an input signal path of a first amplifier stage, and electrically couple the second antenna to an output signal path of the first amplifier stage. The first DPDT switch is further configured to, when the repeater is operating in the uplink operating mode, electrically couple the second antenna to the input signal path of the first amplifier stage, and electrically couple the first antenna to the output signal path of the first amplifier stage.

In yet another embodiment, a non-transitory computer readable medium embodying a computer program is provided. The computer program includes program code that, when executed by a processor of a device, causes the device to control a first DPDT switch to operate the device in one of a downlink operating mode or an uplink operating mode. The first DPDT switch is configured to, when the device is operating in the downlink operating mode, electrically couple the first antenna to an input signal path of a first amplifier stage, and electrically couple the second antenna to an output signal path of the first amplifier stage. The first DPDT switch is further configured to, when the device is operating in the uplink operating mode, electrically couple the second antenna to the input signal path of the first amplifier stage, and electrically couple the first antenna to the output signal path of the first amplifier stage.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate” as well as derivatives thereof, encompass both direct and indirect communication. The terms “include” and “comprise” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example of time division duplexing according to embodiments of the present disclosure;

FIG. 5 illustrates an example wireless network including a repeater according to embodiments of the present disclosure;

FIG. 6 illustrates an example repeater according to embodiments of the present disclosure;

FIG. 7 illustrates an example wireless repeater architecture according to embodiments of the present disclosure;

FIGS. 8A-8B illustrate an example reciprocal repeater architecture according to embodiments of the present disclosure;

FIG. 9 illustrates another example reciprocal repeater architecture according to embodiments of the present disclosure;

FIG. 10 illustrates another example reciprocal repeater architecture according to embodiments of the present disclosure;

FIG. 11 illustrates another example reciprocal repeater architecture according to embodiments of the present disclosure;

FIG. 12 illustrates another example reciprocal repeater architecture according to embodiments of the present disclosure; and

FIG. 13 illustrates an example method for operating a repeater according to embodiments of the present disclosure.

### DETAILED DESCRIPTION

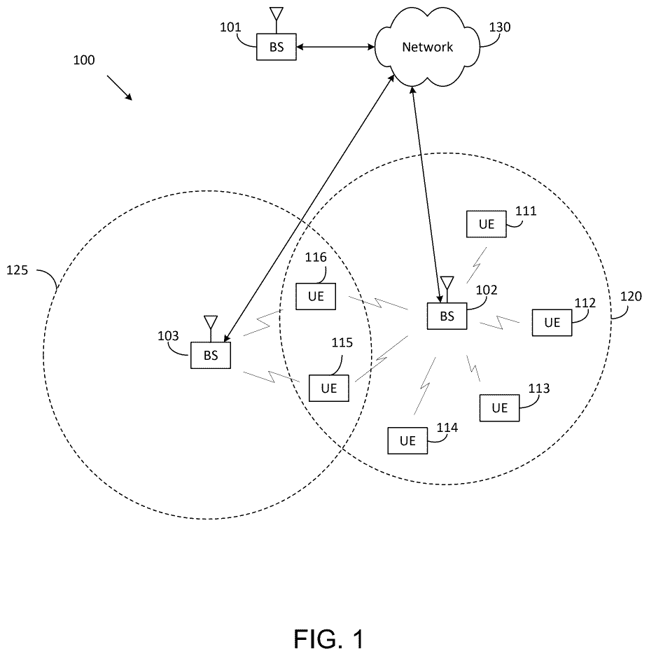

FIGS. 1 through 13, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station”, “subscriber station”, “remote terminal”, “wireless terminal”, “receive point”, “customer premise equipment (CPE)”, or “user device”. For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for wireless communication in a wireless communication system with a reciprocal wireless repeater. In certain embodiments, one or more of the gNBs 101-103 includes circuitry, programing, or a combination thereof, to support communication in a wireless communication system with a reciprocal wireless repeater.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

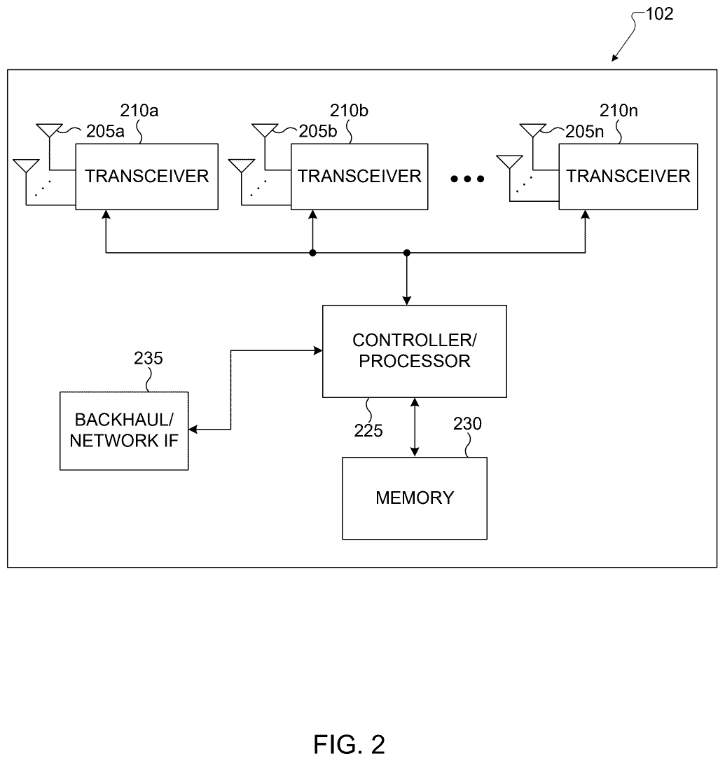

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to support communication in a wireless communication system with a reciprocal wireless repeater as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

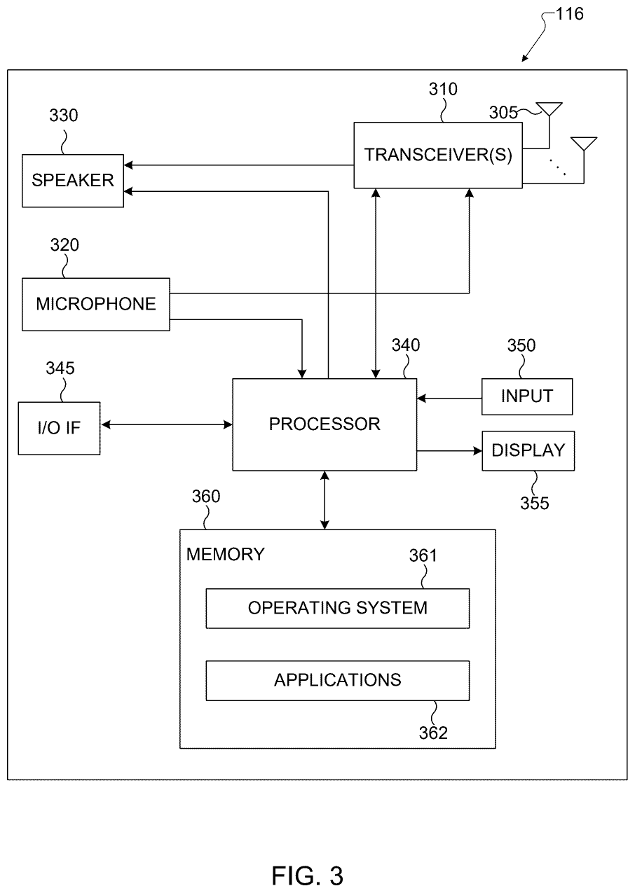

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for communication in a wireless communication system with a reciprocal wireless repeater as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

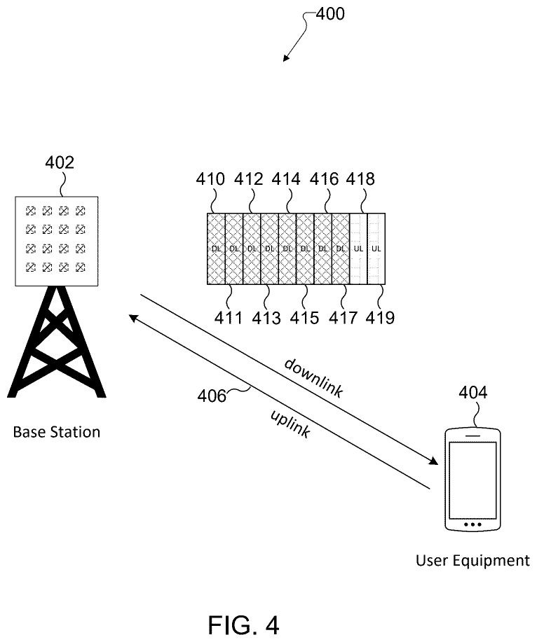

In some wireless networks, for example wireless networks providing fixed wireless access (FWA) services, a Time Division Duplex (TDD) system is employed that utilizes time division multiplexing of the downlink (DL) and uplink (UL) traffic of multiple users through separate time slots as shown in FIG. 4.

FIG. 4 illustrates an example of time division duplexing 400 according to embodiments of the present disclosure. The embodiment of time division multiplexing of FIG. 4 is for illustration only. Different embodiments of time division multiplexing could be used without departing from the scope of this disclosure.

In the example of FIG. 4, a base station (BS) 402 and a user equipment (UE) 404 are communicating over a communications channel 406 according to a time division multiplexing (TDM) scheme. The TDM scheme of FIG. 4 includes a plurality of time slots 410-419. Time slots 410-417 are assigned to downlink communication, and time slots 418 and 419 are assigned to uplink communication. During times slots 410-417, BS 402 may transmit on communication channel 406, and the transmissions may be received by UE 404. During time slots 418-419, UE 404 may transmit on communication channel 406, and the transmissions may be received by BS 402.

Although FIG. 4 illustrates an example time division duplexing 400, various changes may be made to FIG. 4. For example, various changes to time slot assignments could be made, additional UEs may utilize the communication channel, etc. according to particular needs.

In some wireless networks, for example wireless networks providing fixed wireless access (FWA) services, a signal repeater may be employed to boost the node coverage of a BS. Signal repeaters are used in wireless and wireline communication systems to overcome excessive path loss. The main function of a signal repeater is to receive, amplify, and retransmit an up-link and/or down-link signal without signal quality degradation. In the present disclosure a signal repeater may also be referred to as a wireless repeater or a repeater.

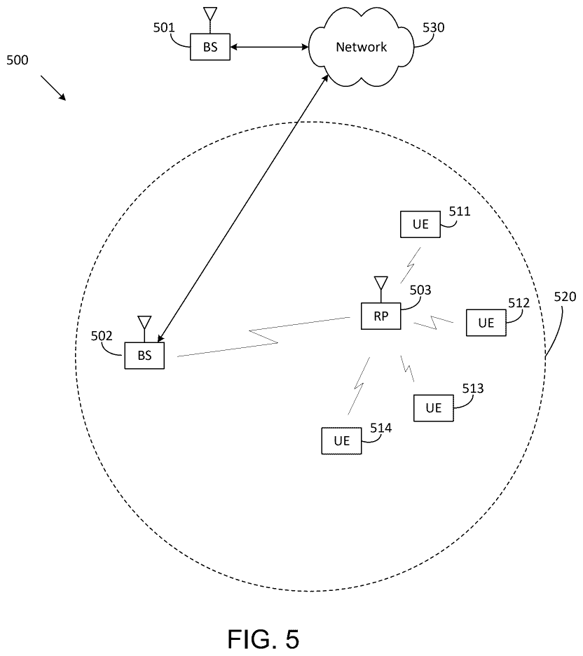

FIG. 5 illustrates an example wireless network 500 including a repeater according to embodiments of the present disclosure. The embodiment of the wireless network 500 shown in FIG. 5 is for illustration only. Other embodiments of the wireless network 500 could be used without departing from the scope of this disclosure.

As shown in FIG. 5, the wireless network includes a gNB 401 (e.g., base station, BS), a gNB 402, and a repeater (RP) 403. The gNB 501 communicates with the gNB 502. The gNB 501 also communicates with at least one network 530, such as the Internet, a proprietary Internet Protocol (IP) network, or other data network.

The gNB 502 provides wireless broadband access to the network 530 for a plurality of user equipments (UEs) within a coverage area 520 of the gNB 502. The plurality of UEs includes a UE 511, 512, 513, and 514 which may be located in a home or small business with a poor line of site to gNB 502. To improve communication with UEs 511-514, repeater 503 may be located in near the homes or the small business where UEs 511-514 are operating, and may relay signals between gNB 502 and UEs 511-514. In some embodiments, one or more of the gNBs 501-502 and repeater 503 may communicate with each other and with the UEs 511-514 using 5G/NR, long term evolution (LTE), long term evolution-advanced (LTE-A), WiMAX, WiFi, or other wireless communication techniques. In some embodiments, one or more of the gNBs 501-502 and repeater 503 may communicate with each other and with the UEs 511-514 using time division duplexing, similar as described regarding FIG. 4.

Dotted lines show the approximate extents of the coverage area 520 a which is shown as approximately circular for the purposes of illustration and explanation only. It should be clearly understood that the coverage areas associated with gNBs, such as the coverage area 520 may have other shapes, including irregular shapes, depending upon the configuration of the gNBs and variations in the radio environment associated with natural and man-made obstructions.

Similar as previously described regarding UEs 111-116 of FIG. 1, one or more of the UEs 511-514 include circuitry, programing, or a combination thereof, for communication in a wireless communication system with a reciprocal wireless repeater. In certain embodiments, one or more of the gNBs 501-502 and repeater 503 includes circuitry, programing, or a combination thereof, to support communication in a wireless communication system with a reciprocal wireless repeater similar as previously described.

Although FIG. 5 illustrates one example of a wireless network 500, various changes may be made to FIG. 5. For example, the wireless network could include any number of gNBs, any number of repeaters, and any number of UEs in any suitable arrangement. Also, the gNB 501 could communicate directly with any number of UEs and provide those UEs with wireless broadband access to the network 530. Similarly, gNB 502 could communicate directly with the network 530 and provide UEs with direct wireless broadband access to the network 530. Further, the gNBs 501 and 502 could provide access to other or additional external networks, such as external telephone networks or other types of data networks.

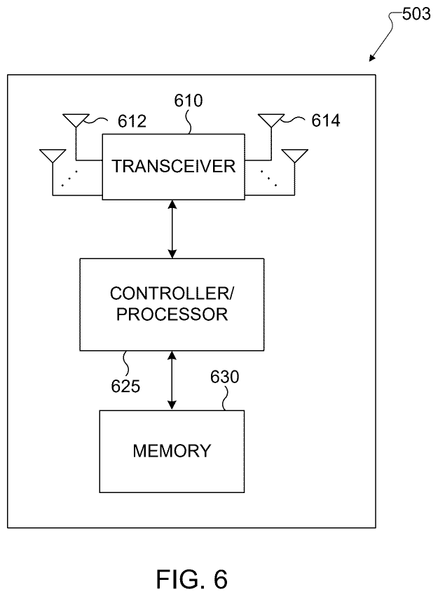

FIG. 6 illustrates an example repeater 503 according to embodiments of the present disclosure. The embodiment of the repeater illustrated in FIG. 6 is for illustration only, other repeaters could have the same or similar configuration. However, repeaters come in a wide variety of configurations, and FIG. 6 does not limit the scope of this disclosure to any particular implementation of a repeater.

As shown in FIG. 6, the repeater 503 includes a transceiver 610, antennas 612 and 614, a controller/processor 625, and memory 630.

Transceiver 610 receives from the antennas 612 and 614, incoming RF signals, such as signals transmitted by gNB 502 and UEs in the network 500. Transceiver 610 down-converts the incoming RF signals to generate IF or baseband signals. The IF or baseband signals are processed by receive (RX) processing circuitry in transceivers 610 and/or controller/processor 625, which generates processed baseband signals by filtering, and/or digitizing the baseband or IF signals. The controller/processor 625 may further process the baseband signals. In some embodiments, transceiver 610 may include one or more amplifier stages. An amplifier stage may include a single amplifier, an amplifier group, an amplifier set, an amplifier chain, and/or the like.

Antennas 612 and 614 may configured for communication with particular devices within a wireless network. For example, in some embodiments, antenna 612 may be configured to transmit to and receive from BS 502, while Antenna 614 may be configured to transmit to and receive from the UEs in the network 500. While antennas 612 and 614 are described as individual antennas, it should be understood that antenna 612 and/or 614 may comprise more than one antenna, an array of multiple antennas, etc.

Transmit (TX) processing circuitry in transceiver 610 and/or controller/processor 625 receives analog or digital data (such as voice data, web data, e-mail, or interactive video game data) from the controller/processor 625. The TX processing circuitry multiplexes, and/or digitizes the outgoing baseband data to generate processed baseband or IF signals. Transceiver 610 up-converts the baseband or IF signals to RF signals that are transmitted via the antennas 612 and 614.

The controller/processor 625 can include one or more processors or other processing devices that control the overall operation of the repeater 503. For example, the controller/processor 625 could control the reception of UL channel signals and the transmission of DL channel signals by transceiver 610 in accordance with well-known principles. The controller/processor 625 could support additional functions as well, such as more advanced wireless communication functions. For instance, the controller/processor 625 could support beam forming or directional routing operations in which outgoing/incoming signals from/to multiple antennas 612 and 614 are weighted differently to effectively steer the outgoing signals in a desired direction. Any of a wide variety of other functions could be supported in the repeater 503 by the controller/processor 625.

The controller/processor 625 is also capable of executing programs and other processes resident in the memory 630, such as an OS and, for example, processes to a support or enable a reciprocal architecture of a reciprocal wireless repeater as discussed in greater detail below. The controller/processor 625 can move data into or out of the memory 630 as required by an executing process.

The memory 630 is coupled to the controller/processor 625. Part of the memory 630 could include a RAM, and another part of the memory 630 could include a Flash memory or other ROM.

Although FIG. 6 illustrates one example of a repeater 503, various changes may be made to FIG. 6. For example, repeater 503 could include any number of each component shown in FIG. 6. Also, various components in FIG. 6 could be combined, further subdivided, or omitted and additional components could be added according to particular needs.

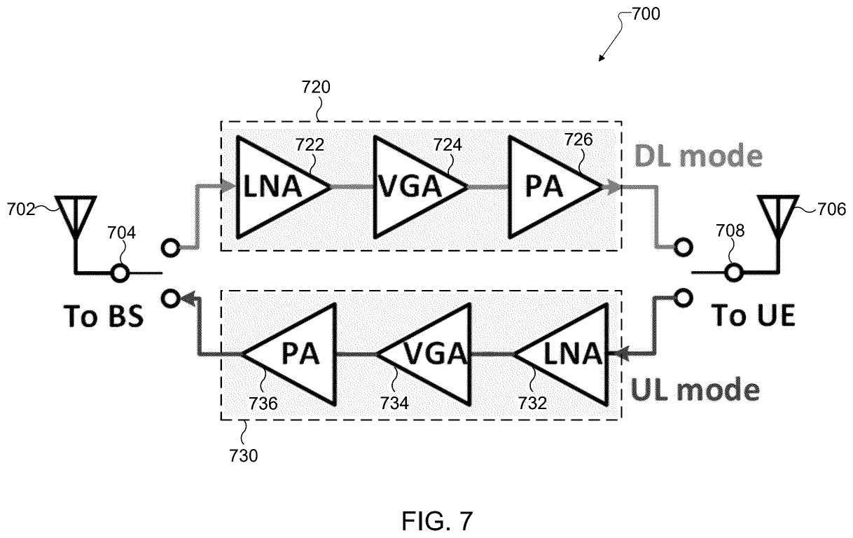

Signal repeaters, such as repeater 503 may employ various architectures. For example, repeater 503 could employ various transceiver configurations. An example architecture for a signal repeater is shown in FIG. 7.

FIG. 7 illustrates an example wireless repeater architecture 700 according to embodiments of the present disclosure. The embodiment of the wireless repeater architecture illustrated in FIG. 7 is for illustration only, other repeaters could have the same or similar configuration. However, repeaters come in a wide variety of configurations, and FIG. 7 does not limit the scope of this disclosure to any particular implementation of a repeater.

In the example of FIG. 7, wireless repeater architecture 700 includes antennas 702 and 706, as well as amplifier chains 720 and 730. Wireless repeater architecture 700 is configured to include a downlink (DL) mode and an uplink (UL) mode.

In the DL mode, a signal received from a base station (e.g., BS 502 of FIG. 5) via antenna 702 is amplified by amplifier chain 720, which includes a low noise amplifier (LNA) 722, variable gain amplifier (VGA) 724, and power amplifier (PA) 726. The signal is first amplified by LNA 722, and then by PA 726, which is optimized for maximum power transfer and power added efficiency. VGA 724, inserted between LNA 722 and PA 726 is an optional component that may be used to tune the gain of amplifier chain 720. The repeated signal, which is several orders higher in power at the output of PA 726 is transmitted to a UE (e.g., UE 511 of FIG. 5) via antenna 706.

In the UL mode, the signal direction is reversed. A signal received from a UE (e.g., UE 511 of FIG. 5) via antenna 706 is amplified by amplifier chain 730, which includes a low noise amplifier (LNA) 732, variable gain amplifier (VGA) 734, and power amplifier (PA) 736. The signal is first amplified by LNA 732, and then by PA 736, which is optimized for maximum power transfer and power added efficiency. VGA 734, inserted between LNA 732 and PA 736 is an optional component that may be used to tune the gain of amplifier chain 730. The repeated signal, which is several orders higher in power at the output of PA 736 is transmitted to a base station (e.g., BS 502 of FIG. 5) via antenna 702.

To select between DL and UL mode, wireless repeater architecture 700 includes two single pole double throw (SPDT) switches 704 and 708. Switches 704 and 708 may be controlled by a processor (e.g., processor 625 of FIG. 6). During DL mode, switch 704 is configured to switch antenna 702 into the input of amplifier chain 720, and switch 708 is configured to switch antenna 706 into the output of amplifier chain 720. During UL mode, switch 704 is configured to switch antenna 702 into the output of amplifier chain 730, and switch 708 is configured to switch antenna 706 into the input of amplifier chain 730.

Although FIG. 7 illustrates one example of a wireless repeater architecture 700, various changes may be made to FIG. 7. For example, wireless repeater architecture 700 could include any number of each component shown in FIG. 7. Also, various components in FIG. 7 could be combined, further subdivided, or omitted and additional components could be added according to particular needs. For example, while FIG. 7 shows that wireless repeater architecture 700 includes amplifier chain 720 and an amplifier chain 730, amplifier chains 720 and 730 could be replaced with single amplifiers, amplifier groups, amplifier sets, and/or the like.

A repeater utilizing different amplifier chains for UL and DL such as illustrated in the example of FIG. 7 will break the channel reciprocity, which is an important benefit in 5G Time Division Duplex (TDD) systems. Channel reciprocity enables TDD systems to estimate UL/DL channel properties from DL/UL channel measurements directly, therefore significantly reducing the overhead in the channel estimation and increasing the spectral efficiency compared to Frequency Division Duplex (FDD) systems. Various embodiments of the present disclosure provide reciprocal signal repeater architectures compatible with 5G TDD operation.

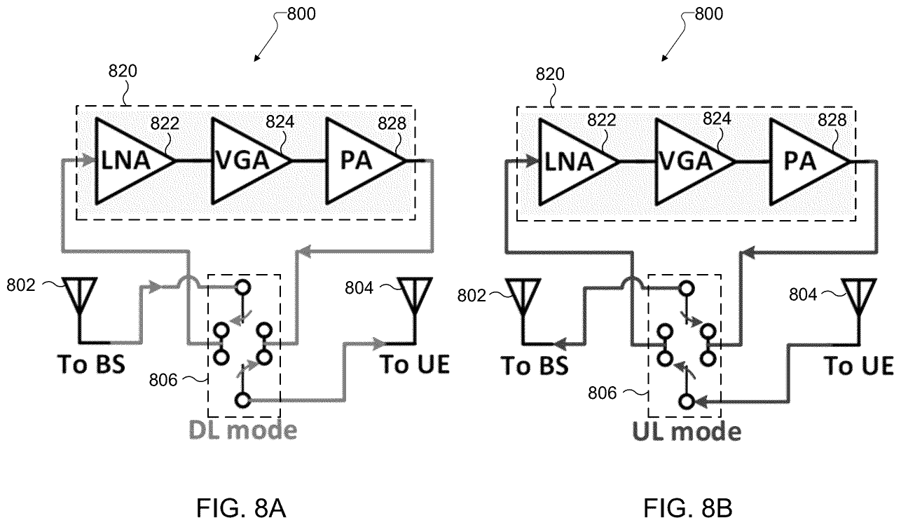

FIGS. 8A-8B illustrate an example reciprocal repeater architecture 800 according to embodiments of the present disclosure. The embodiment of a reciprocal repeater architecture of FIGS. 8A-8B is for illustration only. Different embodiments of a reciprocal repeater architecture could be used without departing from the scope of this disclosure.

In the example of FIGS. 8A-8B, reciprocal repeater architecture 800 includes antennas 802 and 804, as well as a shared amplifier chain 820. Architecture 800 is configured to include a downlink (DL) mode and an uplink (UL) mode. FIG. 8A depicts the DL mode of reciprocal repeater architecture 800. FIG. 8B depicts the DL mode of reciprocal repeater architecture 800.

In the DL mode, a signal received from a base station (e.g., BS 502 of FIG. 5) via antenna 802 is amplified by amplifier chain 820, which includes a low noise amplifier (LNA) 822, variable gain amplifier (VGA) 824, and power amplifier (PA) 828. The signal is first amplified by LNA 822, and then by PA 828, which is optimized for maximum power transfer and power added efficiency. VGA 824, inserted between LNA 822 and PA 828 is an optional component that may be used to tune the gain of amplifier chain 820. The repeated signal, which is several orders higher in power at the output of PA 828 is transmitted to a UE (e.g., UE 511 of FIG. 5) via antenna 804.

In the UL mode, the signal direction is reversed. A signal received from a UE (e.g., UE 511 of FIG. 5) via antenna 804 is amplified by amplifier chain 820. The signal is first amplified by LNA 822, and then by PA 828. The repeated signal, which is several orders higher in power at the output of PA 828 is transmitted to a base station (e.g., BS 502 of FIG. 5) via antenna 802.

To select between DL and UL mode, wireless repeater architecture 800 includes a double pole double throw (DPDT) switch 806. Switch 806 may be controlled by a processor (e.g., processor 625 of FIG. 6). During DL mode, switch 806 is configured to switch antenna 802 into the input of amplifier chain 820, and to switch antenna 804 into the output of amplifier chain 820. During UL mode, switch 806 is configured to switch antenna 802 into the output of amplifier chain 820, and to switch antenna 804 into the input of amplifier chain 820.

Assuming the interfaces are well matched, channel reciprocity may be maintained using reciprocal repeater architecture 800 because the same antennas and amplifier chain are utilized.

Although FIGS. 8A-8B illustrate an example reciprocal repeater architecture 800, various changes may be made to FIGS. 8A-8B. For example, various changes to amplifier chain 820 could be made, antennas 802 and 804 could each be antenna arrays, etc. according to particular needs. For example, while FIGS. 8A-8B shows that wireless repeater architecture 800 includes amplifier chain 820, amplifier chains 820 could be replaced with a single amplifier, an amplifier group, an amplifier set, and/or the like.

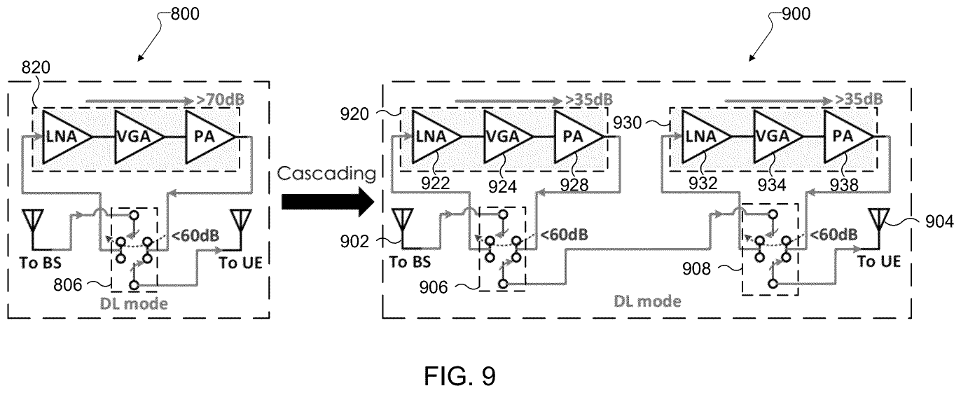

While FIGS. 8A-8B show an example reciprocal repeater architecture that includes a single amplifier chain, embodiments of reciprocal repeaters according to the present disclosure may include a plurality of cascaded amplifier stages, where each amplifier stage includes associated switching. Each amplifier stage and its associated switching is referred to herein as a reciprocal unit or a unit. For a stable repeater, the feedback signal due to limited switch leakages should be small enough to provide a loop gain <1. With a cascaded multiple reciprocal unit structure, a switch isolation requirement can be lower for the same feedforward gain. Similarly, for the same switch isolation, a cascaded multiple reciprocal unit architecture allows for a much higher feedforward gain. An example embodiment of a reciprocal repeater architecture with cascaded units is shown in FIG. 9.

FIG. 9 illustrates another example reciprocal repeater architecture 900 according to embodiments of the present disclosure. The embodiment of a reciprocal repeater architecture of FIG. 9 is for illustration only. Different embodiments of a reciprocal repeater architecture could be used without departing from the scope of this disclosure.

In FIG. 9, in addition to showing reciprocal repeater architecture 900, reciprocal repeater architecture 800 is repeated for convenience. Reciprocal repeater architecture 800 is depicted as providing greater than 70 dB of gain via amplifier chain 820. Switch 806 is depicted as having switch isolation about or less than 60 dB at C-band (4-8 GHz) and 5G mmWave frequencies (20-40 GHz). Assuming a feedforward gain of 70 dB, the loop gain of reciprocal repeater architecture 800 will be 10, making the repeater prone to oscillate.

In the example of FIG. 9, reciprocal repeater architecture 900 includes antennas 902 and 904, as well as a shared amplifier chain including a first amplifier stage 920 and a second amplifier stage 930. While the example of FIG. 9 illustrates amplifier stages 920 and 930 as amplifier chains, it should be understood that an amplifier stage as described herein may refer to a single amplifier, an amplifier group, an amplifier set, an amplifier chain, and/or the like. Architecture 900 is configured to include a DL mode and a UL mode. FIG. 9 depicts the DL mode of reciprocal repeater architecture 900. The UL mode of reciprocal repeater architecture 900 is not shown.

In the DL mode, a signal received from a base station (e.g., BS 502 of FIG. 5) via antenna 902 is amplified by amplifier stage 920, which includes a LNA 922, VGA 924, and PA 928. The signal is first amplified by LNA 922, and then by PA 928, which is optimized for maximum power transfer and power added efficiency. VGA 924, inserted between LNA 922 and PA 928 is an optional component that may be used to tune the gain of amplifier chain 920. The repeated signal, which is several orders higher in power at the output of PA 928 is further amplified by amplifier stage 930, which includes a LNA 932, VGA 934, and PA 938. The signal is first amplified by LNA 932, and then by PA 938, which is optimized for maximum power transfer and power added efficiency. VGA 934, inserted between LNA 932 and PA 938 is an optional component that may be used to tune the gain of amplifier stage 930. The repeated signal, which is several orders higher in power at the output of PA 938 is transmitted to a UE (e.g., UE 511 of FIG. 5) via antenna 904.

In the UL mode, the signal direction is reversed. A signal received from a UE (e.g., UE 511 of FIG. 5) via antenna 904 is amplified by amplifier stage 930, and then further amplified by amplifier stage 920. The signal is first amplified by LNA 932, and then by PA 938. The repeated signal, which is several orders higher in power at the output of PA 938 is further amplified by LNA 922, and then by PA 928. The repeated signal, which is several orders higher in power at the output of PA 928 is transmitted to a base station (e.g., BS 502 of FIG. 5) via antenna 902.

To select between DL and UL mode, wireless repeater architecture 900 includes a first DPDT switch 906, and a second DPDT switch 908. Switches 806 and 908 may be controlled by a processor (e.g., processor 625 of FIG. 6). During DL mode, switch 906 is configured to switch antenna 902 into the input of amplifier stage 920, and to switch the output of amplifier stage 920 into the input of amplifier stage 930. During DL mode, switch 908 is configured to switch the input of amplifier stage 930 into the output of amplifier stage 920, and to switch antenna 904 into the output of amplifier stage 930.

During UL mode, switch 906 is configured to switch antenna 902 into the output of amplifier stage 920, and switch the input of amplifier stage 920 into the output of amplifier stage 930. During UL mode, switch 908 is configured to switch the output of amplifier stage 930 into the input of amplifier stage 920, and to switch antenna 904 into the input of amplifier stage 930.

Amplifier stages 920 and 930 are each depicted as providing greater than 35 dB of gain, and switches 906 and 908 are each depicted as having switch isolation about or less than 60 dB at C-band (4-8 GHZ) and 5G mmWave frequencies (20-40 GHz). Due to the cascading of amplifier stages 920 and 930, assuming the feedforward gain is 70 dB, amplifier stages 920 and 930 may each produce only 35 dB gain. Therefore, the loop gain within either of amplifier stages 920 and 930 would be well below one, allowing a stable repeater.

Although FIG. 9 illustrates an example reciprocal repeater architecture 900, various changes may be made to FIG. 9. For example, while amplifier stages 920 and 930 are shown as being identical, amplifier stages 920 and 930 may be of any design, and a reciprocal repeater according to the present disclosure may include amplifier stages of different design cascaded together. Furthermore, while FIG. 9 shows that reciprocal repeater architecture 900 includes first and second shared amplifier stages, a reciprocal repeater according to the present disclosure may include any number of amplifier stages.

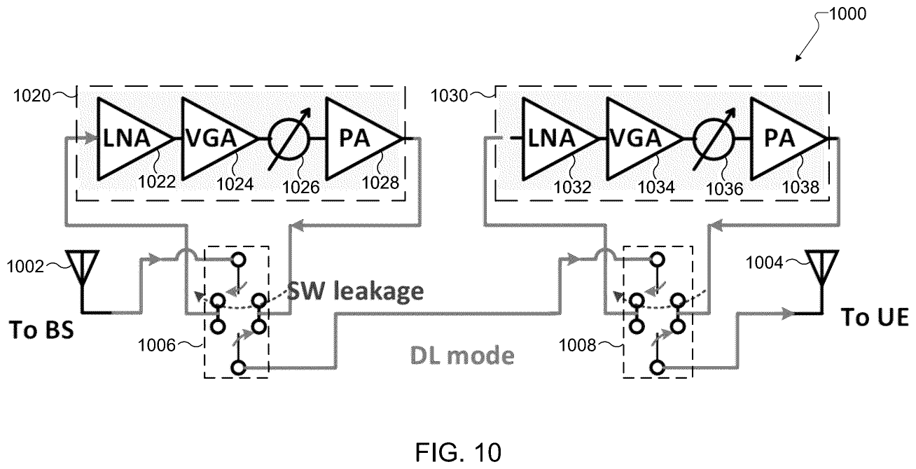

In some embodiments, a reciprocal repeater architecture (for example, as shown in FIG. 9) may include one or more phase shifters at any point in the amplifier chain as shown in FIG. 10. The one or more phase shifters may be utilized to correct for any potential phase shift due to variable gain or other non-idealities in the amplifier chain. The phase shifter settings can be different in the UL and DL mode. Such a phase-shift function can be realized through an explicit stand-alone phase shifter or an integrated stage in the amplifier that can provide a similar function.

FIG. 10 illustrates another example reciprocal repeater architecture 1000 according to embodiments of the present disclosure. The embodiment of a reciprocal repeater architecture of FIG. 10 is for illustration only. Different embodiments of a reciprocal repeater architecture could be used without departing from the scope of this disclosure.

In the example of FIG. 10, reciprocal repeater architecture 1000 includes antennas 1002 and 1004, as well as a shared amplifier chain including a first amplifier stage 1020 and a second amplifier stage 1030. While the example of FIG. 10 illustrates amplifier stages 1020 and 1030 as amplifier chains, it should be understood that an amplifier stage as described herein may refer to a single amplifier, an amplifier group, an amplifier set, an amplifier chain, and/or the like. Architecture 1000 is configured to include a DL mode and a UL mode. FIG. 10 depicts the DL mode of reciprocal repeater architecture 1000. The UL mode of reciprocal repeater architecture 1000 is not shown.

In the DL mode, a signal received from a base station (e.g., BS 502 of FIG. 5) via antenna 1002 is amplified by amplifier stage 1020, which includes a LNA 1022, VGA 1024, phase shifter 1026, and PA 1028. The signal is first amplified by LNA 1022, and then by PA 1028, which is optimized for maximum power transfer and power added efficiency. VGA 1024, inserted between LNA 1022 and PA 1028 is an optional component that may be used to tune the gain of amplifier chain 1020. The repeated signal, which is several orders higher in power at the output of PA 1028 is further amplified by amplifier stage 1030, which includes a LNA 1032, VGA 1034, phase shifter 1036 and PA 1038. The signal is first amplified by LNA 1032, and then by PA 1038, which is optimized for maximum power transfer and power added efficiency. VGA 1034, inserted between LNA 1032 and PA 1038 is an optional component that may be used to tune the gain of amplifier stage 1030. The repeated signal, which is several orders higher in power at the output of PA 1038 is transmitted to a UE (e.g., UE 511 of FIG. 5) via antenna 1004.

In the UL mode, the signal direction is reversed. A signal received from a UE (e.g., UE 511 of FIG. 5) via antenna 1004 is amplified by amplifier stage 1030, and then further amplified by amplifier stage 1020. The signal is first amplified by LNA 1032, and then by PA 1038. The repeated signal, which is several orders higher in power at the output of PA 1038 is further amplified by LNA 1022, and then by PA 1028. The repeated signal, which is several orders higher in power at the output of PA 1028 is transmitted to a base station (e.g., BS 502 of FIG. 5) via antenna 1002.

The phase shifter symbols (1026 and 1036) shown in FIG. 10 merely represent the phase shifting function rather than the location or implementation of the phase shifter(s). The phase shifter(s) may be located at any point in the amplifier chain and may be of any design.

To select between DL and UL mode, wireless repeater architecture 1000 includes a first DPDT switch 1006, and a second DPDT switch 1008. Switches 1006 and 1008 may be controlled by a processor (e.g., processor 625 of FIG. 6). During DL mode, switch 1006 is configured to switch antenna 1002 into the input of amplifier stage 1020, and to switch the output of amplifier stage 1020 into the input of amplifier stage 1030. During DL mode, switch 1008 is configured to switch the input of amplifier stage 1030 into the output of amplifier stage 1020, and to switch antenna 1004 into the output of amplifier stage 1030.

During UL mode, switch 1006 is configured to switch antenna 1002 into the output of amplifier stage 1020, and switch the input of amplifier stage 1020 into the output of amplifier stage 1030. During UL mode, switch 1008 is configured to switch the output of amplifier stage 1030 into the input of amplifier stage 1020, and to switch antenna 1004 into the input of amplifier stage 1030.

Although FIG. 10 illustrates an example reciprocal repeater architecture 1000, various changes may be made to FIG. 10. For example, while amplifier stages 1020 and 1030 are shown as being identical, amplifier stages 1020 and 1030 may be of any design, and a reciprocal repeater according to the present disclosure may include amplifier stages of different design cascaded together. Furthermore, while FIG. 10 shows that reciprocal repeater architecture 1000 includes first and second shared amplifier stages, a reciprocal repeater according to the present disclosure may include any number of amplifier stages.

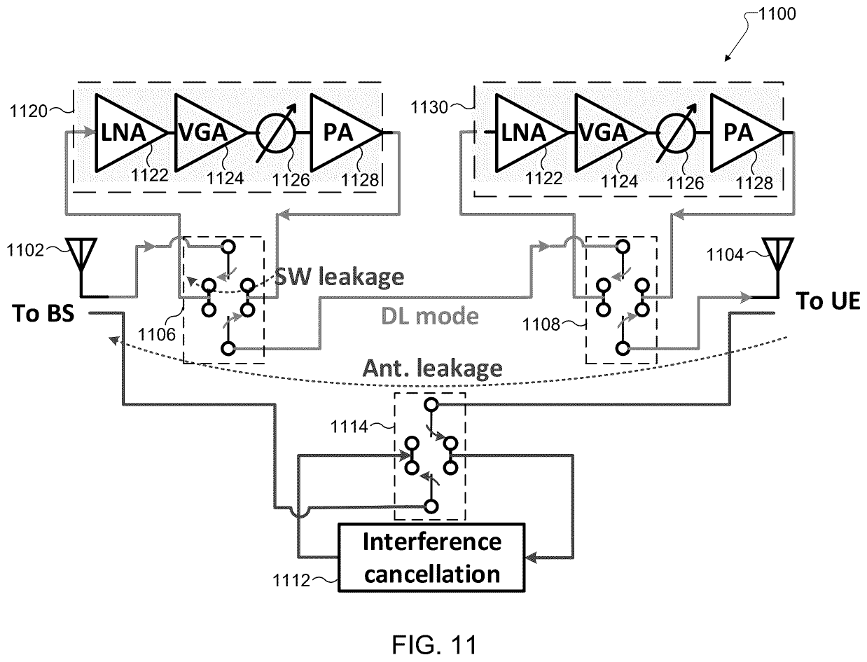

In some embodiments, a reciprocal repeater architecture (for example, as shown in FIG. 10) may include components (e.g., an interference cancellation block) to reduce interference due to antenna to antenna leakage, similar as shown in FIG. 11. The interference cancellation may allow for a higher feedforward gain. The interference cancelation circuitry may be employed in a reciprocal manner similar to the amplifier stages described herein to avoid additional mismatches in the DL and UL modes.

FIG. 11 illustrates another example reciprocal repeater architecture 1100 according to embodiments of the present disclosure. The embodiment of a reciprocal repeater architecture of FIG. 11 is for illustration only. Different embodiments of a reciprocal repeater architecture could be used without departing from the scope of this disclosure.

In the example of FIG. 11, reciprocal repeater architecture 1100 includes antennas 1102 and 1104, as well as a shared amplifier chain including a first amplifier stage 1120 and a second amplifier stage 1130, and an interference cancellation block 1112. While the example of FIG. 11 illustrates amplifier stages 1120 and 1130 as amplifier chains, it should be understood that an amplifier stage as described herein may refer to a single amplifier, an amplifier group, an amplifier set, an amplifier chain, and/or the like. Architecture 1100 is configured to include a DL mode and a UL mode. FIG. 11 depicts the DL mode of reciprocal repeater architecture 1100. The UL mode of reciprocal repeater architecture 1100 is not shown.

In the DL mode, a signal received from a base station (e.g., BS 502 of FIG. 5) via antenna 1102 is amplified by amplifier stage 1120, which includes a LNA 1122, VGA 1124, phase shifter 1126, and PA 1128. The signal is first amplified by LNA 1122, and then by PA 1128, which is optimized for maximum power transfer and power added efficiency. VGA 1124, inserted between LNA 1122 and PA 1128 is an optional component that may be used to tune the gain of amplifier chain 1120. The repeated signal, which is several orders higher in power at the output of PA 1128 is further amplified by amplifier stage 1130, which includes a LNA 1132, VGA 1134, phase shifter 1136 and PA 1138. The signal is first amplified by LNA 1132, and then by PA 1138, which is optimized for maximum power transfer and power added efficiency. VGA 1134, inserted between LNA 1132 and PA 1138 is an optional component that may be used to tune the gain of amplifier stage 1130. The repeated signal, which is several orders higher in power at the output of PA 1138 is transmitted to a UE (e.g., UE 511 of FIG. 5) via antenna 1104.

In the UL mode, the signal direction is reversed. A signal received from a UE (e.g., UE 511 of FIG. 5) via antenna 1104 is amplified by amplifier stage 1130, and then further amplified by amplifier stage 1120. The signal is first amplified by LNA 1132, and then by PA 1138. The repeated signal, which is several orders higher in power at the output of PA 1138 is further amplified by LNA 1122, and then by PA 1128. The repeated signal, which is several orders higher in power at the output of PA 1128 is transmitted to a base station (e.g., BS 502 of FIG. 5) via antenna 1102.

The phase shifter symbols (1126 and 1136) shown in FIG. 11 merely represent the phase shifting function rather than the location or implementation of the phase shifter(s). The phase shifter(s) may be located at any point in the amplifier chain and may be of any design.

To select between DL and UL mode, wireless repeater architecture 1100 includes a first DPDT switch 1106, a second DPDT switch 1108, and a third DPDT switch 1114. Switches 1106, 1108, and 1114 may be controlled by a processor (e.g., processor 625 of FIG. 6). During DL mode, switch 1106 is configured to switch antenna 1102 into the input of amplifier stage 1120, and to switch the output of amplifier stage 1120 into the input of amplifier stage 1130. During DL mode, switch 1108 is configured to switch the input of amplifier stage 1130 into the output of amplifier stage 1120, and to switch antenna 1104 into the output of amplifier stage 1130. During DL mode, switch 1114 is configured to switch antenna 1102 into the output of interference cancellation block 1112, and to switch antenna 1104 into the input of interference cancellation block 1112.

During UL mode, switch 1106 is configured to switch antenna 1102 into the output of amplifier stage 1120, and switch the input of amplifier stage 1120 into the output of amplifier stage 1130. During UL mode, switch 1108 is configured to switch the output of amplifier stage 1130 into the input of amplifier stage 1120, and to switch antenna 1104 into the input of amplifier stage 1130. During UL mode, switch 1114 is configured to switch antenna 1102 into the input of interference cancellation block 1112, and to switch antenna 1104 into the output of interference cancellation block 1112.

Although FIG. 11 illustrates an example reciprocal repeater architecture 1100, various changes may be made to FIG. 11. For example, while amplifier stages 1120 and 1130 are shown as being identical, amplifier stages 1120 and 1130 may be of any design, and a reciprocal repeater according to the present disclosure may include amplifier stages of different design cascaded together. Furthermore, while FIG. 11 shows that reciprocal repeater architecture 1100 includes first and second shared amplifier stages, a reciprocal repeater according to the present disclosure may include any number of amplifier stages.

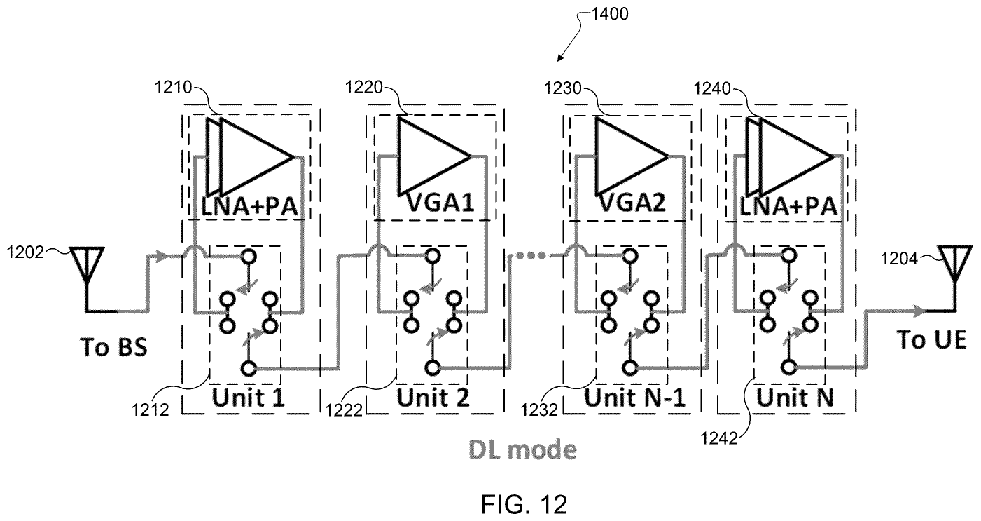

As previously described herein, embodiments of reciprocal repeaters according to the present disclosure may include any number of reciprocal units, and each reciprocal unit may be of a different design. An example reciprocal repeater architecture with differing reciprocal units is shown in FIG. 12.

FIG. 12 illustrates another example reciprocal repeater architecture 1200 according to embodiments of the present disclosure. The embodiment of a reciprocal repeater architecture of FIG. 12 is for illustration only. Different embodiments of a reciprocal repeater architecture could be used without departing from the scope of this disclosure.

In the example of FIG. 12, reciprocal repeater architecture 1200 includes antennas 1202 and 1204, as well as a shared chain of reciprocal units 1 through N. Unit 1 includes a first amplifier stage 1210 and a first DPDT switch 1212. Unit 2 includes a second amplifier stage 1220 and a second DPDT switch 1222. Unit N-1 includes an N-1th amplifier stage 1230 and an N-1th DPDT switch 1232. Unit N includes an Nth amplifier stage 1240, and an Nth DPDT switch 1242. Architecture 1200 is configured to include a DL mode and a UL mode. FIG. 12 depicts the DL mode of reciprocal repeater architecture 1200. The UL mode of reciprocal repeater architecture 1200 is not shown. While not shown, it should be understood that reciprocal repeater architecture 1200 may include any number of additional reciprocal units. For example, reciprocal repeater architecture 1200 may include a unit 3, a unit N-2, etc. cascaded between unit 2 and unit N-1.

As shown in FIG. 12 amplifier stages 1210 and 1240 include LNA and PA capabilities, while amplifier stages 1220 and 1230 include VGA capabilities. However, the amplifier stages of FIG. 12 may be of any design according to particular needs.

In the DL mode, a signal received from a base station (e.g., BS 502 of FIG. 5) via antenna 1202 is amplified by the LNA capability of amplifier stage 1210. In the example of FIG. 9, the PA capability of amplifier stage 1210 is not utilized during the DL mode. The signal is further amplified by amplifier stage 1220, any additional amplifier stages between amplifier stage 1220 and 1230, and amplifier stage 1230 before reaching amplifier stage 1240. At amplifier stage 1240, the signal is amplified by the PA capability of amplifier stage 1240, which is optimized for maximum power transfer and power added efficiency. In the example of FIG. 9, the LNA capability of amplifier stage 1240 is not utilized during the DL mode. The repeated signal, which is several orders higher in power at the output of amplifier stage 1240 is transmitted to a UE (e.g., UE 511 of FIG. 5) via antenna 1204. While the example of FIG. 12 illustrates amplifier stages 1210-1240 as single amplifiers or amplifier sets, it should be understood that an amplifier stage as described herein may refer to a single amplifier, an amplifier group, an amplifier set, an amplifier chain, and/or the like.

In the UL mode, the signal direction is reversed. A signal received from a UE (e.g., UE 511 of FIG. 5) via antenna 1204 is amplified by the LNA capability of amplifier stage 1240. In the example of FIG. 9, the PA capability of amplifier stage 1240 is not utilized during the UL mode. The signal is further amplified by amplifier stage 1230, any additional amplifier stages between amplifier stage 1230 and 1220, and amplifier stage 1220 before reaching amplifier stage 1210. At amplifier stage 1210, the signal is amplified by the PA capability of amplifier stage 1210, which is optimized for maximum power transfer and power added efficiency. In the example of FIG. 9, the LNA capability of amplifier stage 1210 is not utilized during the UL mode. The repeated signal, which is several orders higher in power at the output of amplifier stage 1240 is transmitted to a base station (e.g., BS 502 of FIG. 5) via antenna 1202.

In the example of FIG. 12, the switches of each unit may be toggled to select between DL and UL mode. Each of the switches 1212 through 1242, as well as any switches not shown, may be controlled by a processor (e.g., processor 625 of FIG. 6). During DL mode, switch 1212 is configured to switch antenna 1202 into the input of amplifier stage 1210, and to switch the output of amplifier stage 1210 into the input of amplifier stage 1220. During DL mode, switch 1222 is configured to switch the input of amplifier stage 1220 into the output of amplifier stage 1220, and to switch the output of amplifier stage 1220 in the input of the next amplifier stage (e.g., an amplifier stage of a unit 3, an amplifier stage of a unit N-2, amplifier stage 1230, etc.). During DL mode, switch 1232 is configured to switch the input of amplifier stage 1230 into the output of the previous amplifier stage (e.g., an amplifier stage of a unit 3, an amplifier stage of a unit N-2, amplifier stage 1220, etc.) and to switch the output of amplifier stage 1230 into the input of amplifier stage 1240. During DL mode, switch 1242 is configured to switch the input of amplifier stage 1240 into the output of amplifier stage 1230, and to switch antenna 1204 into the output of amplifier stage 1140. While not shown, the switches of any additional reciprocal units (e.g., a switch of a unit 3, a switch of a unit N-2, etc.) may be configured to similarly cascade the amplifier chains during DL mode.

During UL mode, switch 1212 is configured to switch antenna 1202 into the output of amplifier stage 1210, and to switch the input of amplifier stage 1210 into the output of amplifier stage 1220. During UL mode, switch 1222 is configured to switch the output of amplifier stage 1220 into the input of amplifier stage 1220, and to switch the input of amplifier stage 1220 in the output of the previous amplifier stage (e.g., an amplifier stage of a unit 3, an amplifier stage of a unit N-2, amplifier stage 1230, etc.). During UL mode, switch 1232 is configured to switch the output of amplifier stage 1230 into the input of the next amplifier stage (e.g., an amplifier stage of a unit 3, an amplifier stage of a unit N-2, amplifier stage 1220, etc.) and to switch the input of amplifier stage 1230 into the output of amplifier stage 1240. During UL mode, switch 1242 is configured to switch the output of amplifier stage 1240 into the input of amplifier stage 1230, and to switch antenna 1204 into the input of amplifier stage 1240. While not shown, the switches of any additional reciprocal units (e.g., a switch of a unit 3, a switch of a unit N-2, etc.) may be configured to similarly cascade the amplifier chains during UL mode.

Although FIG. 12 illustrates an example reciprocal repeater architecture 1200, various changes may be made to FIG. 12. For example, while FIG. 12 shows that reciprocal repeater architecture 1200 includes at least 4 shared amplifier stages, a reciprocal repeater according to the present disclosure may include any number of amplifier stages of any design. Also, while antennas 1202 and 1204 are depicted as individual antennas, antennas 1202 and 1204 could each be antenna arrays, etc. according to particular needs.

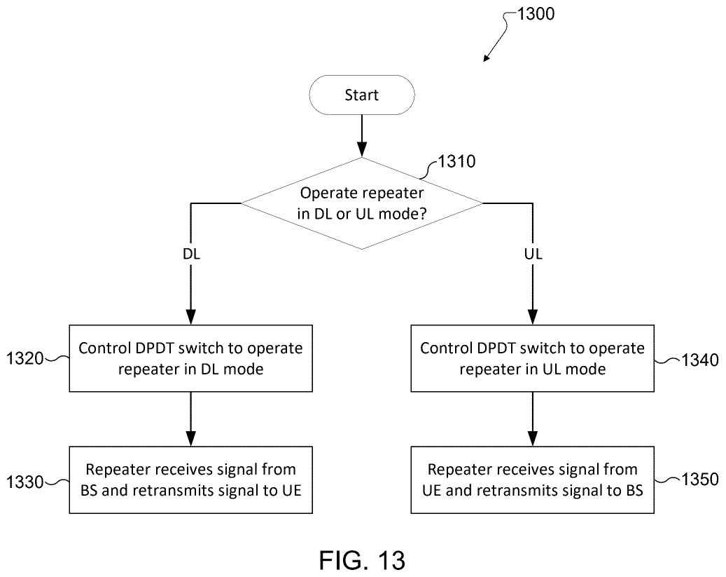

FIG. 13 illustrates an example method for operating a repeater 1300 according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a method for operating a repeater could be used without departing from the scope of this disclosure.

In the example of FIG. 13, the method begins at step 1310. At step 1310, a determination is made (for example, by a processor such as processor 625 of FIG. 6) whether to operate a repeater in a downlink operating mode or an uplink operating mode. The repeater may be similar to any of the repeaters described herein. For example, the repeater utilize the architecture of any of repeater architectures 503, 800, 900, 1000, 1100, 1200, etc. If the determination is made to operate the repeater in the downlink operating mode, the method proceeds to step 1320. Otherwise, if the determination is made to operate the repeater in the uplink operating mode, the method proceeds to step 1340.

At step 1320, a DPDT switch is controlled (for example, by processor 625) to operate the repeater in the downlink operating mode. In some embodiments, the DPDT switch may be a first DPDT switch. In some embodiments, the first DPDT switch may be configured to, when the repeater is operating in the downlink operating mode, electrically couple a first antenna configured to transmit and receive RF signals from a base station BS to an input signal path of a first amplifier stage, and electrically couple a second antenna configured to transmit and receive RF signals from a UE to an output signal path of the first amplifier stage.

In some embodiments, at step 1320, the method may further include controlling a second DPDT switch. In some embodiments, the first DPDT switch may be configured to, when the repeater is operating in the downlink operating mode, electrically couple, in collaboration with the second DPDT switch, the output signal path the a first amplifier stage to an input signal path of a second amplifier stage, and electrically couple the first antenna to an input signal path of the first amplifier stage. In some embodiments, the second DPDT switch may be configured to, when the repeater is operating in the downlink operating mode, electrically couple, in collaboration with the first DPDT switch, the input signal path of the second amplifier stage to the output signal path of the first amplifier stage, and electrically couple the second antenna to the output signal path of the second amplifier stage.

In some embodiments, at step 1320, the method may further include controlling a third DPDT switch. The third DPDT switch may be configured to, when the repeater is operating in the downlink operating mode, electrically couple a feedback path of the first antenna to an output signal path of an interference cancellation block, and electrically couple a feedback path of the second antenna to an input signal path of the interference cancellation block.

In some embodiments, at step 1320, the method may include controlling N DPDT switches. The N DPDT switches may be configured to, when the repeater is operating in the downlink operating mode, cascade N amplifier stages such that the first amplifier stage operates as an input to the transceiver and the Nth amplifier stage operates as an output to the transceiver, electrically couple the first antenna to an input signal path of the first amplifier stage, and electrically couple the second antenna to an output signal path of the Nth amplifier stage. In some embodiments, the first amplifier stage and the Nth amplifier stage each include an LNA capability and a PA capability. In some embodiments, the first amplifier stage is configured to, when the repeater is operating in the downlink operating mode, operate utilizing the LNA capability while refraining from operating using the PA capability, and the Nth amplifier stage is configured to, when the repeater is operating in the uplink operating mode, operate utilizing the LNA capability while refraining from operating using the PA capability.

At step 1330, the repeater receives a signal from a BS and retransmits the signal to a UE.

At step 1340, the DPDT switch is controlled (for example, by processor 625) to operate the repeater in the uplink operating mode. In some embodiments, the DPDT switch may be a first DPDT switch. In some embodiments, the first DPDT switch may be configured to, when the repeater is operating in the uplink operating mode, electrically couple the second antenna to the input signal path of the first amplifier stage, and electrically couple the first antenna to the output signal path of the first amplifier stage.

In some embodiments, at step 1340, the method may further include controlling a second DPDT switch. In some embodiments, the first DPDT switch may be configured to, when the repeater is operating in the uplink operating mode, electrically couple, in collaboration with the first DPDT switch, the output signal path of the second amplifier stage to the input signal path of the first amplifier stage, and electrically couple the first antenna to the output signal path of the first amplifier stage. In some embodiments, the second DPDT switch may be configured to, when the repeater is operating in the uplink operating mode, electrically couple, collaboration with the first DPDT switch, the output signal path of the second amplifier stage to the input signal path of the first amplifier stage, and electrically couple the first antenna to the input signal path of the second amplifier stage.

In some embodiments, at step 1340, the method may further include controlling a third DPDT switch. The third DPDT switch may be configured to, when the repeater is operating in the uplink operating mode, electrically couple the feedback path of the second antenna to the output signal path of an interference cancellation block, and electrically couple the feedback path of the first antenna to the input signal path of the interference cancellation block.

In some embodiments, at step 1340, the method may include controlling N DPDT switches. The NDPDT switches may be configured to, when the repeater is operating in the uplink operating mode, cascade the N amplifier stages such that the Nth amplifier stage operates as the input to the transceiver and the first amplifier stage operates as the output to the transceiver, electrically couple the second antenna to the input signal path of the Nth amplifier stage, and electrically couple the first antenna to the output signal path of the first amplifier stage. In some embodiments, the first amplifier stage and the Nth amplifier stage each include an LNA capability and a PA capability. In some embodiments, the first amplifier stage is configured to, when the repeater is operating in the uplink operating mode, operate utilizing the PA capability while refraining from operating using the LNA capability, and the Nth amplifier stage is configured to, when the repeater is operating in the downlink operating mode, operate utilizing the PA capability while refraining from operating using the LNA capability.

At step 1350, the repeater receives a signal from the UE and retransmits the signal to the BS.

Although FIG. 13 illustrates one example method for operating a repeater 1300, various changes may be made to FIG. 13. For example, while shown as a series of steps, various steps in FIG. 13 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A repeater comprising:
a first antenna configured to transmit and receive radio frequency (RF) signals from a base station (BS);
a second antenna configured to transmit and receive RF signals from a user equipment (UE);
a processor configured to control an operating mode of the repeater; and
a transceiver operatively coupled to the processor, the transceiver comprising:
a first amplifier stage; and
a first double pole double throw (DPDT) switch configured to:
when the repeater is operating in a downlink operating mode, electrically couple the first antenna to an input signal path of the first amplifier stage, and electrically couple the second antenna to an output signal path of the first amplifier stage; and
when the repeater is operating in an uplink operating mode, electrically couple the second antenna to the input signal path of the first amplifier stage, and electrically couple the first antenna to the output signal path of the first amplifier stage.

2. The repeater of claim 1, wherein:
the transceiver further comprises:
a second amplifier stage; and
a second DPDT switch;
the first DPDT switch is configured to:
when the repeater is operating in the downlink operating mode, electrically couple, in collaboration with the second DPDT switch, the output signal path of the first amplifier stage to an input signal path of the second amplifier stage, and electrically couple the first antenna to an input signal path of the first amplifier stage; and
when the repeater is operating in the uplink operating mode, electrically couple, in collaboration with the second DPDT switch, an output signal path of the second amplifier stage to the input signal path of the first amplifier stage, and electrically couple the first antenna to the output signal path of the first amplifier stage; and
the second DPDT switch is configured to:
when the repeater is operating in the downlink operating mode, electrically couple, in collaboration with the first DPDT switch, the input signal path of the second amplifier stage to the output signal path of the first amplifier stage, and electrically couple the second antenna to the output signal path of the second amplifier stage; and
when the repeater is operating in the uplink operating mode, electrically couple, in collaboration with the first DPDT switch, the output signal path of the second amplifier stage to the input signal path of the first amplifier stage, and electrically couple the second antenna to an input signal path of the second amplifier stage.

3. The repeater of claim 2, wherein at least one of the first amplifier stage or the second amplifier stage comprises:
a low noise amplifier (LNA) including an input of the respective amplifier stage;
a variable gain amplifier (VGA) including an input electrically coupled to an output signal path of the LNA; and
a power amplifier (PA) including an output of the respective amplifier stage and an input electrically coupled to an output signal path of the VGA.

4. The repeater of claim 3, wherein at least one of the first amplifier stage or the second amplifier stage further comprises a phase shifter including an input electrically coupled to the output signal path of the LNA or to the output signal path of the VGA and an output electrically coupled to an input signal path of the VGA or to an input signal path of the PA, respectively.

5. The repeater of claim 4, further comprising:
an interference cancellation block; and
a third DPDT switch configured to:
when the repeater is operating in the downlink operating mode, electrically couple a feedback path of the first antenna to an output signal path of the interference cancellation block, and electrically couple a feedback path of the second antenna to an input signal path of the interference cancellation block; and
when the repeater is operating in the uplink operating mode, electrically couple the feedback path of the second antenna to the output signal path of the interference cancellation block, and electrically couple the feedback path of the first antenna to the input signal path of the interference cancellation block.

6. The repeater of claim 1, wherein:
the transceiver comprises at least N amplifier stages including the first amplifier stage, where N is greater than 1;
the first amplifier stage and the Nth amplifier stage each include an LNA capability and a PA capability;
the first amplifier stage is configured to:
when the repeater is operating in the downlink operating mode, operate utilizing the LNA capability while refraining from operating using the PA capability; and
when the repeater is operating in the uplink operating mode, operating utilizing the PA capability while refraining from operating using the LNA capability;
the Nth amplifier stage is configured to:
when the repeater is operating in the uplink operating mode, operate utilizing the LNA capability while refraining from operate using the PA capability; and
when the repeater is operate in the downlink operating mode, operating utilizing the PA capability while refraining from operating using the LNA capability;
the transceiver comprises N DPDT switches, including the first DPDT switch; and
the N DPDT switches are configured to:
when the repeater is operating in the downlink operating mode, cascade the N amplifier stages such that the first amplifier stage operates as an input to the transceiver and the Nth amplifier stage operates as an output to the transceiver, electrically couple the first antenna to an input signal path of the first amplifier stage, and electrically couple the second antenna to an output signal path of the Nth amplifier stage; and
when the repeater is operating in the uplink operating mode, cascade the N amplifier stages such that the Nth amplifier stage operates as the input to the transceiver and the first amplifier stage operates as the output to the transceiver, electrically couple the second antenna to the input signal path of the Nth amplifier stage, and electrically couple the first antenna to the output signal path of the first amplifier stage.

7. The repeater of claim 6, wherein:
N is at least 3; and
the second through N-1th amplifier stages each comprise a VGA.

8. A method of operating a repeater, the method comprising:
controlling a first double pole double throw (DPDT) switch to operate the repeater in one of a downlink operating mode or an uplink operating mode,
wherein the first DPDT switch is configured to:
when the repeater is operating in the downlink operating mode, electrically couple a first antenna configured to transmit and receive radio frequency (RF) signals from a base station (BS) to an input signal path of a first amplifier stage, and electrically couple a second antenna configured to transmit and receive RF signals from a user equipment (UE) to an output signal path of the first amplifier stage; and
when the repeater is operating in the uplink operating mode, electrically couple the second antenna to the input signal path of the first amplifier stage, and electrically couple the first antenna to the output signal path of the first amplifier stage.

9. The method of claim 8, the method further comprising:
controlling a second DPDT switch to operate the repeater in one of the downlink operating mode or the uplink operating mode,
wherein the first DPDT switch is configured to:
when the repeater is operating in the downlink operating mode, electrically couple, in collaboration with the second DPDT switch, the output signal path of a first amplifier stage to an input signal path of a second amplifier stage, and electrically couple the first antenna to an input signal path of the first amplifier stage; and
when the repeater is operating in the uplink operating mode, electrically couple, in collaboration with the second DPDT switch, an output signal path of the second amplifier stage to the input signal path of the first amplifier stage, and electrically couple the first antenna to the output signal path of the first amplifier stage; and
wherein the second DPDT switch is configured to:
when the repeater is operating in the downlink operating mode, electrically couple, in collaboration with the first DPDT switch, the input signal path of the second amplifier stage to the output signal path of the first amplifier stage, and electrically couple the second antenna to the output signal path of the second amplifier stage; and
when the repeater is operating in the uplink operating mode, electrically couple, in collaboration with the first DPDT switch, the output signal path of the second amplifier stage to the input signal path of the first amplifier stage, and electrically couple the second antenna to the input signal path of the second amplifier stage.

10. The method of claim 9, wherein at least one of the first amplifier stage or the second amplifier stage comprises:
a low noise amplifier (LNA) including an input of the respective amplifier stage;
a variable gain amplifier (VGA) including an input electrically coupled to an output signal path of the LNA; and
a power amplifier (PA) including an output of the respective amplifier stage and an input electrically coupled to an output signal path of the VGA.

11. The method of claim 10, wherein at least one of the first amplifier stage or the second amplifier stage further comprises a phase shifter including an input electrically coupled to the output signal path of the LNA or to the output signal path of the VGA and an output electrically coupled to an input signal path of the VGA or to an input signal path of the PA, respectively.

12. The method of claim 11, further comprising:
controlling a third DPDT switch to operate the repeater in one of the downlink operating mode or the uplink operating mode,
wherein the third DPDT switch is configured to:
when the repeater is operating in the downlink operating mode, electrically couple a feedback path of the first antenna to an output signal path of an interference cancellation block, and electrically couple a feedback path of the second antenna to an input signal path of the interference cancellation block; and
when the repeater is operating in the uplink operating mode, electrically couple the feedback path of the second antenna to the output signal path of the interference cancellation block, and electrically couple the feedback path of the first antenna to the input signal path of the interference cancellation block.

13. The method of claim 8, further comprising:
controlling N DPDT switches, including the first DPDT switch, to operate the repeater in one of the downlink operating mode or the uplink operating mode,
wherein:
the repeater comprises at least N amplifier stages including a first amplifier stage, where N is greater than 1;
the first amplifier stage and the Nth amplifier stage each include an LNA capability and a PA capability;
the first amplifier stage is configured to:
when the repeater is operating in the downlink operating mode, operate utilizing the LNA capability while refraining from operating using the PA capability; and
when the repeater is operating in the uplink operating mode, operating utilizing the PA capability while refraining from operating using the LNA capability;
the Nth amplifier stage is configured to:
when the repeater is operating in the uplink operating mode, operate utilizing the LNA capability while refraining from operate using the PA capability; and
when the repeater is operating in the downlink operating mode, operating utilizing the PA capability while refraining from operate using the LNA capability; and
the N DPDT switches are configured to:
when the repeater is operating in the downlink operating mode, cascade the N amplifier stages such that the first amplifier stage operates as an input to a transceiver and the Nth amplifier stage operates as an output to the transceiver, electrically couple the first antenna to an input signal path of the first amplifier stage, and electrically couple the second antenna to an output signal path of the Nth amplifier stage; and
when the repeater is operating in the uplink operating mode, cascade the N amplifier stages such that the Nth amplifier stage operates as the input to the transceiver and the first amplifier stage operates as the output to the transceiver, electrically couple the second antenna to the input signal path of the Nth amplifier stage, and electrically couple the first antenna to the output signal path of the first amplifier stage.

14. The method of claim 13, wherein:
N is at least 3; and
the second through N-1th amplifier stages each comprise a VGA.

15. A non-transitory computer readable medium embodying a computer program, the computer program comprising program code that, when executed by a processor of a device, causes the device to:
control a first double pole double throw (DPDT) switch to operate the device in one of a downlink operating mode or an uplink operating mode,
wherein the first DPDT switch is configured to:
when the device is operating in the downlink operating mode, electrically couple a first antenna configured to transmit and receive radio frequency (RF) signals from a base station (BS) to an input signal path of a first amplifier stage, and electrically couple a second antenna configured to transmit and receive RF signals from a user equipment (UE) to an output signal path of the first amplifier stage; and
when the device is operating in the uplink operating mode, electrically couple the second antenna to the input signal path of the first amplifier stage, and electrically couple the first antenna to the output signal path of the first amplifier stage.

16. The non-transitory computer readable medium of claim 15, wherein the program code, when executed by the processor of the device, further causes the device to:
control a second DPDT switch to operate the device in one of the downlink operating mode or the uplink operating mode,
wherein the first DPDT switch is configured to:
when the device is operating in the downlink operating mode, electrically couple, in collaboration with the second DPDT switch, the output signal path of a first amplifier stage to an input signal path of a second amplifier stage, and electrically couple the first antenna to an input signal path of the first amplifier stage; and
when the device is operating in the uplink operating mode, electrically couple, in collaboration with the second DPDT switch, an output signal path of the second amplifier stage to the input signal path of the first amplifier stage, and electrically couple the first antenna to the output signal path of the first amplifier stage; and
wherein the second DPDT switch is configured to:
when the device is operating in the downlink operating mode, electrically couple, in collaboration with the first DPDT switch, the input signal path of the second amplifier stage to the output signal path of the first amplifier stage, and electrically couple the second antenna to the output signal path of the second amplifier stage; and
when the device is operating in the uplink operating mode, electrically couple, in collaboration with the first DPDT switch, the output signal path of the second amplifier stage to the input signal path of the first amplifier stage, and electrically couple the second antenna to the input signal path of the second amplifier stage.

17. The non-transitory computer readable medium of claim 16, wherein at least one of the first amplifier stage or the second amplifier stage comprises:
a low noise amplifier (LNA) including an input of the respective amplifier stage;
a variable gain amplifier (VGA) including an input electrically coupled to an output signal path of the LNA; and
a power amplifier (PA) including an output of the respective amplifier stage and an input electrically coupled to an output signal path of the VGA.

18. The non-transitory computer readable medium of claim 17, wherein at least one of the first amplifier stage or the second amplifier stage further comprises a phase shifter including an input electrically coupled to the output signal path of the LNA or the output signal path of the VGA and an output electrically coupled to an input signal path of the VGA or to an input signal path of the PA, respectively.

19. The non-transitory computer readable medium of claim 18, wherein the program code, when executed by the processor of the device, further causes the device to:
control a third DPDT switch to operate the device in one of the downlink operating mode or the uplink operating mode,
wherein the third DPDT switch is configured to:
when the device is operating in the downlink operating mode, electrically couple a feedback path of the first antenna to an output signal path of an interference cancellation block, and electrically couple a feedback path of the second antenna to an input signal path of the interference cancellation block; and
when the device is operating in the uplink operating mode, electrically couple the feedback path of the second antenna to the output signal path of the interference cancellation block, and electrically couple the feedback path of the first antenna to the input signal path of the interference cancellation block.

20. The non-transitory computer readable medium of claim 15, wherein the program code, when executed by the processor of the device, further causes the device to:
control N DPDT switches, including the first DPDT switch, to operate the device in one of the downlink operating mode or the uplink operating mode,
wherein:
the device comprises at least N amplifier stages including a first amplifier stage, where N is at least 3;
the first amplifier stage and the Nth amplifier stage each include an LNA capability and a PA capability;
the second through N-1th amplifier stages each comprise a VGA;
the first amplifier stage is configured to:
when the device is operating in the downlink operating mode, operate utilizing the LNA capability while refraining from operating using the PA capability; and
when the device is operating in the uplink operating mode, operate utilizing the PA capability while refraining from operating using the LNA capability;
the Nth amplifier stage is configured to:
when the device is operating in the uplink operating mode, operate utilizing the LNA capability while refraining from operating using the PA capability; and
when the device is operating in the downlink operating mode, operate utilizing the PA capability while refraining from operating using the LNA capability; and
the N DPDT switches are configured to:
when the device is operating in the downlink operating mode, cascade the N amplifier stages such that the first amplifier stage operates as an input to a transceiver and the Nth amplifier stage operates as an output to the transceiver, electrically couple the first antenna to an input signal path of the first amplifier stage, and electrically couple the second antenna to an output signal path of the Nth amplifier stage; and
when the device is operating in the uplink operating mode, cascade the N amplifier stages such that the Nth amplifier stage operates as the input to the transceiver and the first amplifier stage operates as the output to the transceiver, electrically couple the second antenna to the input signal path of the Nth amplifier stage, and electrically couple the first antenna to the output signal path of the first amplifier stage.
